(19) United States
(12) Patent Application Publication
(10) Pub. No.: US 2024/0067346 A1
(43) Pub. Date: Feb. 29, 2024

(54) SUPPLEMENTARY THRUST GENERATING APPARATUS

(71) Applicant: Changman LEE, Seoul (KR)

(72) Inventor: Changman LEE, Seoul (KR)

(21) Appl. No.: 18/234,895

(22) Filed: Aug. 17, 2023

(30) Foreign Application Priority Data
Aug. 30, 2022 (KR) 10-2022-0108934

(51) Int. Cl. B64D 27/02

(52) U.S. Cl. CPC B64D 27/02

(57) ABSTRACT

A technical object of the present invention is to provide a supplementary thrust generating apparatus which may apply additional force to an object in a thrust direction while applying a thrust to an object by a propulsion device, wherein the supplementary thrust generating apparatus as a supplementary thrust generating apparatus used for an object having a propulsion device is provided on an outer surface of the object, and converts an external pressure applied to the object while the object is propelled by the propulsion device, and generates a supplementary thrust in the same direction as a thrust direction of the propulsion device.

### TECHNICAL FIELD

The present invention relates to a supplementary thrust generating apparatus installed in an object (an air plane or ship) having a propulsion device to further provide a supplementary thrust to a thrust of the propulsion device.

### BACKGROUND ART

In general, as an object with a propulsion device, a plane or a ship is known. The airplane further includes a body (airframe) accommodating a person or object and wings providing a lift based on a thrust of the propulsion device. The ship further includes a body (ship body) accommodating the person or object, and propelled based through the thrust of the propulsion device.

However, when the thrust is applied to the object having the propulsion device by the propulsion device, the object is propelled in a thrust direction, but there is a limit that additional force cannot be applied in the thrust direction.

### DISCLOSURE

### Technical Problem

A technical object of the present invention is to provide a supplementary thrust generating apparatus which may apply additional force to an object in a thrust direction while applying a thrust to an object by a propulsion device.

### Technical Solution

In order to achieve the object, a supplementary thrust generating apparatus according to an embodiment of the present invention as a supplementary thrust generating apparatus used for an object having a propulsion device is provided on an outer surface of the object, and converts an external pressure applied to the object while the object is propelled by the propulsion device, and generates a supplementary thrust in the same direction as a thrust direction of the propulsion device.

The supplementary thrust generating apparatus according to an embodiment of the present invention may include: an inner support unit provided on an outer surface of the object; an outer support unit provided at an interval from the inner support unit; and a plurality of thrust conversion units provided between the inner support unit and the outer support unit, and converting the external pressure applied to the outer support unit into the supplementary thrust, and transferring the supplementary thrust to the inner support unit.

Each thrust conversion unit may include a thrust conversion member having a long shape placed to be inclined to form an acute angle with respect to the outer support unit in the thrust direction and form an obtuse angle with respect to the inner support unit, and including one end portion provided at the inner support unit and the other end portion provided at the outer support unit.

Each thrust conversion unit may further include a fixation unit firmly fixing one end portion of the thrust conversion member to the inner support unit, and a hinge unit rotatably provide the other end portion of the thrust conversion member at the outer support unit.

The outer support unit may include an outer support frame in which the hinge unit is provided, and an outer main skin converting the outer support frame and directly receiving the external pressure.

A part or the entirety of an outer circumference of the object may form a curved surface. In this case, the outer support unit may include a first outer support section positioned to correspond to a part of the curved surface and having a bending shape, and a second outer support section positioned to correspond to the other part of the curved surface and having the bending shape, and the plurality of thrust conversion units may include a first thrust conversion section positioned to correspond to the first outer support section and having two or more thrust conversion members arranged to be parallel to each other, and a second thrust conversion section positioned to correspond to the second outer support section and having two or more thrust conversion members arranged to be parallel to each other.

The thrust conversion member of the first thrust conversion section and the thrust conversion member of the second thrust conversion section may be arranged not to be parallel to each other.

The first outer support section may have the bending shape similarly to a part of the curved surface, and the second outer support section may the bending shape similarly to the other part of the curved surface.

The outer support unit may further include an outer connection skin flexibly connecting the first outer support section and the second outer support section.

The thrust conversion member may be a leaf spring.

The thrust conversion member may be made of steel or a carbon composite.

The outer connection skin may be made of a material having a tensile, elasticity, and a strength. Furthermore, as the material having the tensile, the elasticity, and the strength, special steel or titanium may be used.

The object having the propulsion device may be an airplane or a ship.

When the object having the propulsion device is the airplane, the external pressure may be a pressure which the object receives by an airflow while the object is propelled.

When the object having the propulsion device is the ship, the external pressure may be a pressure which the object receives by waves while the object is propelled.

### Advantageous Effects

As described above, the supplementary thrust generating apparatus according to the embodiment of the present invention may have the following effects.

According to the embodiment of the present invention, as the supplementary thrust generating apparatus used in the having the propulsion device, a technical configuration is provided, which is provided on an outer surface of the object, and converts external pressure applied to the object while the object is propelled in the thrust direction by the propulsion device, and generates a supplementary thrust in a direction which is the same as the thrust direction, so the supplementary thrust can be generated in the direction which is the same as the thrust direction while the thrust (a thrust in a direction in which the object is propelled) is applied to the object (airplane or ship), thereby reducing fuel consumption of the propulsion device or increasing a speed of the object by the supplementary thrust with an output of the same propulsion device.

Further, according to the embodiment of the present invention, a technical configuration is provided, in which the supplementary thrust generating apparatus includes an inner support unit, an outer support unit, and a plurality of thrust conversion units, so when the external support unit is pressed by external pressure applied to the outer support unit, the pressed force can be transferred to the inner support unit while being converted into the supplementary thrust by each thrust conversion unit, and as a result, the object can further receive the supplementary thrust transferred to the inner support unit in addition to the thrust by the propulsion device.

Further, according to the embodiment of the present invention, a technical configuration is provided, in which each thrust conversion unit includes a thrust conversion member, and the thrust conversion member includes one end portion having a long shape placed to be inclined to form an acute angle with respect to the outer support unit in the thrust direction and form an obtuse angle with respect to the inner support unit, and simultaneously placed to be inclined to from the obtuse angle with respect to the outer support unit in an opposite direction to the thrust and form the acute angle with respect to the inner support unit, and provided in the inner support unit, and the other end portion provided in the outer support unit, so when the outer support unit is pressed by the external pressure applied to the outer support unit while the object is propelled in the thrust direction, if thorns which stretched in a diagonal direction, which form a circumference of a male foxtail are grabbed by a hand, the supplementary thrust can be further provided to the object in the thrust direction while the inclined thrust conversion member is pressed while forming the acute angle and the obtuse angle as if the male foxtail moves.

Further, according to the embodiment of the present invention, since a technical configuration is provided, in which each thrust conversion unit further includes a fixation unit and a hinge unit, the pressed force can be smoothly transferred to the other end portion of the thrust conversion member while one end portion of the thrust conversion member is rotated with respect to the outer support unit through the hinge unit while the outer support unit is pressed by the external pressure, and the transferred force can be almost absolutely transferred to the inner support unit through the fixation unit, and even when the external pressure is released, the thrust conversion member is fixed through the fixation unit, so the outer support unit may be moved to an original position so that the thrust conversion member is ready for receiving the external pressure again while a form of the thrust conversion member is restored again by self elasticity of the thrust conversion member.

Further, according to the embodiment of the present invention, since a technical configuration is provided, in which a part or the entirety of an outer circumferential surface of the object form a curved surface, and the outer support unit includes a first outer support section and a second outer support section, the plurality of thrust conversion units includes a first thrust conversion section and a second thrust conversion section, and the first thrust conversion section has two or more thrust conversion members arranged to be parallel to each other and the second thrust conversion section have two or more thrust conversion members arranged to be parallel to each other, when the external pressure is applied to the outer support unit, the supplementary thrust can be smoothly provided to the object through the divided first and second outer support sections and the distinguished first and second thrust conversion sections.

Further, according to the embodiment of the present invention, since a technical configuration is provided, in which the outer support unit further includes an outer connection skin, even though an interval between the first outer support section and the second outer support section is varied through flexible connection of the outer connection skin, the outer support unit can sufficiently permit such a change while being bent according to the varied interval, and a space between the first outer support section and the second outer support section can be sealed by the outer connection skin, so loss of the external pressure applied to the outer support unit can be minimized, and ultimately, loss of the supplementary thrust can be minimized.

### DESCRIPTION OF DRAWINGS

FIG. 1 is a diagram schematically illustrating a state in which a supplementary thrust generating apparatus is mounted on an object (an object having a propulsion device) according to an embodiment of the present invention.

FIG. 2 is a diagram illustrating the supplementary thrust generating apparatus of FIG. 1 taken along line II-II.

FIG. 3 is a diagram schematically illustrating a state in which the supplementary thrust generating apparatus of FIG. 1 is mounted on an airplane.

FIG. 4 is a diagram schematically illustrating a state in which a supplementary thrust apparatus is mounted on an object according to another embodiment of the present invention.

FIG. 5 is a bottom view schematically illustrating a state in which the supplementary thrust generating apparatus of FIG. 4 is mounted on a ship.

### MODE FOR INVENTION

Hereinafter, an embodiment of the present invention will be described more fully hereinafter with reference to the accompanying drawings so as to be easily implemented by those skilled in the art. However, the present invention may be modified in various different ways, all without departing from the spirit or scope of the present invention.

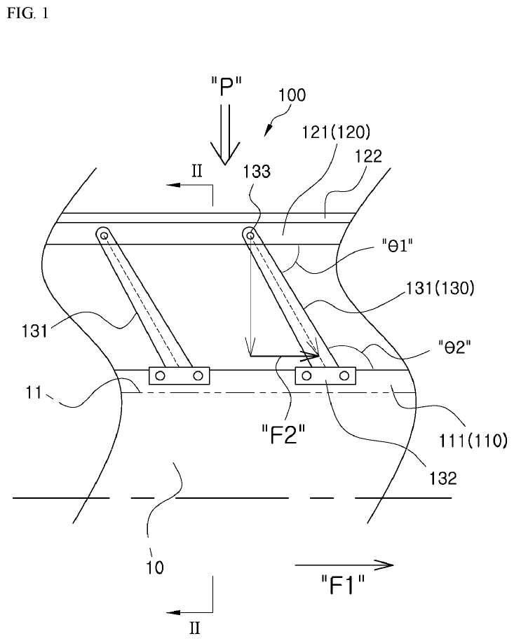

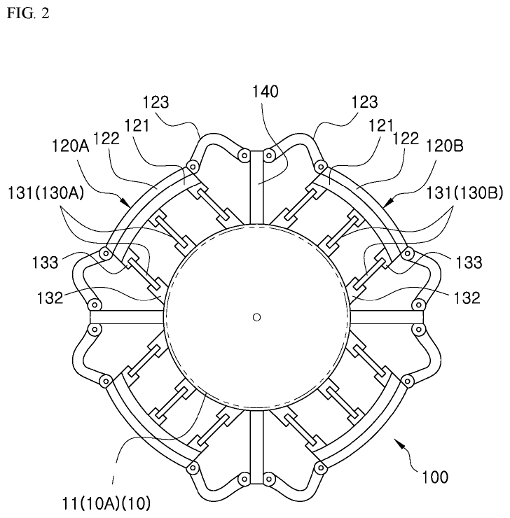

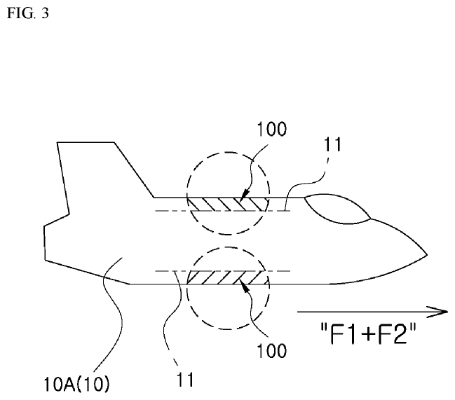

FIG. 1 is a diagram schematically illustrating a state in which a supplementary thrust generating apparatus is mounted on an object (an object having a propulsion device) according to an embodiment of the present invention and FIG. 2 is a diagram illustrating the supplementary thrust generating apparatus of FIG. 1 taken along line II-II. FIG. 3 is a diagram schematically illustrating a state in which the supplementary thrust generating apparatus of FIG. 1 is mounted on an airplane.

As illustrated in FIGS. 1 to 3, the supplementary thrust generating apparatus 100 according to an embodiment of the present invention as a supplementary thrust generating apparatus used in an object (hereinafter, referred to as “object”) such as an airplane 10A or a ship 10B having a propulsion device (not illustrated) is provided on an outer surface of the object 10, and converts an external pressure P applied to the object 10 while the object is propelled in a direction of a thrust F1 by the propulsion device to generate a supplementary thrust F2 in a direction which is the same as the direction of the thrust.

Accordingly, the supplementary thrust F2 may be generated in the same direction as the direction of the thrust F1 while the thrust F1 (a thrust in a direction in which the object is propelled) is applied to the object (airplane or ship) 10 by the propulsion device, so fuel efficiency of the propulsion device may be reduced or in the case of an output of the same propulsion device, a speed of the object 10 may be increased by the supplementary thrust F2.

Hereinafter, the supplementary thrust generating apparatus 100 according to an embodiment of the present invention will be described in more detail by continuously referring to FIGS. 1 to 3.

As illustrated in FIGS. 1 to 3, the supplementary thrust generating apparatus 100 according to an embodiment of the present invention may include an inner support unit 110, an outer support unit 120, and a plurality of thrust conversion units 130.

The inner support unit 110 is a component for supporting the supplementary thrust generating apparatus 100 of the present invention on the object 10. The inner support unit 110 may be fixed onto an outer surface 11 of the object 10 as illustrated in FIGS. 1 and 2. For example, the inner support unit 110 may include a plurality of inner support frames 111 as illustrated in FIGS. 1 and 2. Further, the plurality of inner support frames 111 may be arranged on the outer surface of the object in the form of a grid although not illustrated.

The outer support unit 120 is a component for directly receiving the external pressure applied to the object 10 instead of the outer surface 11 of the object 10. The outer support unit 110 may be provided at an interval from the inner support unit 110 as illustrated in FIGS. 1 and 2. For example, the outer support unit 120 may include an outer support frame 121 and an outer main skin 122 as illustrated in FIGS. 1 and 2. The outer support frame 121 may support the plurality of thrust conversion units 130, and the outer main skin 122 may cover the outer support frame 121 and directly receive the external pressure P.

The plurality of thrust conversion units 130 is a component for converting the external pressure P applied to the outer support unit 120 into the supplementary thrust F2 in the same direction as the direction of the thrust F1, and transferring the supplementary thrust F2 to the inner support unit 110. The plurality of thrust conversion units 130 may be provided between the inner support unit 110 and the outer support unit 120 as illustrated in FIGS. 1 and 2.

Therefore, the components (the inner support unit 110, the outer support unit 120, and the plurality of thrust conversion units 130) are provided, so when the outer support unit 120 is pressed by the external pressure P applied to the outer support unit 120, the pressed force may be transferred to the inner support unit 110 while being converted into the supplementary thrust F2 by each thrust conversion unit 130, and as a result, the object 10 may further receive the supplementary thrust F2 transferred to the inner support unit 110 in addition to the thrust F1 by the autonomous propulsion device.

Specifically, each thrust conversion unit 130 may include a long-shaped thrust conversion member 131 placed to be inclined to form an acute angle θ1 with respect to the outer support unit 120 in the thrust direction and form an obtuse angle θ2 with respect to the inner support unit 110 as illustrated in FIG. 1. Simultaneously, the long-shaped thrust conversion member 131 should form an obtuse angle (an angle acquired by subtracting “θ1” from 180 degrees) with respect to the outer support unit 120 in an opposite direction (a left direction in FIG. 1) to the thrust and form an acute angle (an angle acquired by subtracting “θ2” from 180 degrees) with respect to the inner support unit 110 as illustrated in FIG. 1. Furthermore, one end portion of the thrust conversion unit 131 may be provided at the inner support unit 110 and the other end portion may be provided at the outer support unit 120 as illustrated in FIGS. 1 and 2. For example, as the thrust conversion member 131, a leaf spring having self elasticity may be used. Further, the thrust conversion member 131 may be made of steel or a carbon composite.

Therefore, when the outer support unit 120 is pressed by the external pressure P applied to the outer support unit 120 while the object 10 is propelled in the direction of the thrust F1, if thorns which stretched in a diagonal direction, which form a circumference of a male foxtail (or green foxtail) are grabbed by a hand, the supplementary thrust F2 can be further provided to the object 10 in the direction of the thrust F1 while the inclined thrust conversion member 131 is pressed while forming the acute angle θ1 and the obtuse angle θ2 as if the male foxtail moves (not illustrated) (see FIG. 1).

Moreover, each thrust conversion unit 130 may further include a fixation unit 132 and a hinge unit 133 as illustrated in FIG. 1. The fixation unit 132 may firmly fix one end portion of the thrust conversion member 131 to the inner support unit 110, and the hinge unit 133 may rotatably provide the other end portion of the thrust conversion member 131 at the outer support unit 120. Therefore, the pressed force can be smoothly transferred to the other end portion of the thrust conversion member 131 while one end portion of the thrust conversion member 131 is rotated with respect to the outer support unit 120 through the hinge unit 133 while the outer support unit 120 is pressed by the external pressure P, and the transferred force can be almost absolutely transferred to the inner support unit 110 through the fixation unit 132, and even when the external pressure P is released, the thrust conversion member 131 is fixed through the fixation unit 132, so the outer support unit 120 may be moved to an original position so that the thrust conversion member 131 is ready for receiving the external pressure again while a form of the thrust conversion member 131 is restored again by self elasticity of the thrust conversion member 131.

Meanwhile, the supplementary thrust generating apparatus 100 according to an embodiment of the present invention may be mounted on an airplane 10A as illustrated in FIG. 3 as an example among the objects 10. In this case, the external pressure P may be an air pressure which the airplane 10A receives by an airflow (turbulence, etc.) while the airplane 10A is propelled.

In particular, the entirety of an outer circumferential surface 11 of the airplane 10A may form the curved surface. In this case, so as for the plurality of thrust conversion units 130 to smoothly operate with respect to the curved surface, as illustrated in FIG. 2, the outer support unit 120 may be divided into a plurality of outer support sections including a first outer support section 120A and a second outer support section 120B, and the plurality of thrust conversion units 130 may be distinguished into a plurality of thrust conversion sections including a first thrust conversion section 130A and a second thrust conversion section 130B. For example, the first outer support section 120A may be positioned to correspond to a part of the curved surface and may have a bending shape, and the second outer support section 120B may be positioned to correspond to the other part of the curved surface of the airplane 10A and may have the bending shape. The first thrust conversion section 130A may be positioned to correspond to the first outer support section 120A and may have two or more thrust conversion members 131 arranged to be parallel to each other, and the second thrust conversion section 130B may be positioned to correspond to the second outer support section 120B and may have two or more thrust conversion members 131 arranged to be parallel to each other.

Therefore, even though the supplementary thrust generating apparatus 100 according to an embodiment of the present invention is mounted on the airplane 10A having the curved outer circumference surface 11, the plurality of thrust conversion units 130 may smoothly operate with respect to the curved surface. That is, when the external pressure P is applied to the outer support unit 120, the supplementary thrust F2 may be smoothly provided to the airplane 10A through the divided first and second outer support sections 120A and 120B and the divided first and second thrust conversion sections 130A and 130B (see FIG. 2).

Furthermore, as illustrated in FIG. 2, the thrust conversion member 131 of the first thrust conversion section 130A and the thrust conversion member 131 of the second thrust conversion section 130B may be arranged not to be parallel to each other. Further, as illustrated in FIG. 2, the first outer support section 120A may have the bending shape similarly to a part of the outer circumferential surface 11 of the curved surface of the airplane 10A, and the second outer support section 120B may the bending shape similarly to the other part of the outer circumferential surface 11 of the curved surface of the airplane 10A.

Moreover, the outer support unit 120 may further include an outer connection skin 123 as illustrated in FIG. 2. The outer connection skin 123 may flexibly connect the first outer support section 120A and the second outer support section 120B. For example, the outer connection skin 123 may be made of a well bent flexible material having tensile, elasticity, and strength. Furthermore, as the material having the tensile, the elasticity, and the strength, special steel or titanium may be used.

Therefore, since an interval between the first outer support section 120A and the second outer support section 120B is varied through flexible connection of the outer connection skin 123, the outer support unit 120 can sufficiently permit such a change while being bent according to the varied interval, and a space between the first outer support section 120A and the second outer support section 120B can be sealed by the outer connection skin 123, so loss of the external pressure applied to the outer support unit 120 can be minimized, and ultimately, loss of the supplementary thrust F2 can be minimized.

Furthermore, as illustrated in FIG. 2, against a case where a width of a space in which the outer connection skin 123 is placed is large, an intermediate connection support unit 140 may be further provided therebetween. One end portion of the intermediate connection support unit 140 may be fixed to the inner support unit 110, and the other end portion may protrude in a radial direction of the inner support unit 110.

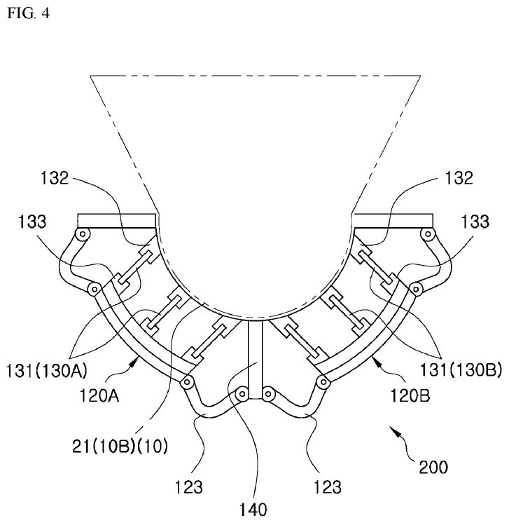

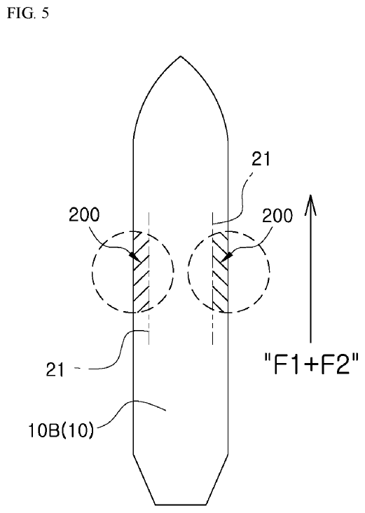

Hereinafter, a supplementary thrust generating apparatus 200 according to another embodiment of the present invention will be described in detail with reference to FIGS. 4 and 5.

FIG. 4 is a diagram schematically illustrating a state in which a supplementary thrust apparatus is mounted on an object according to another embodiment of the present invention and FIG. 5 is a bottom view schematically illustrating a state in which the supplementary thrust generating apparatus of FIG. 4 is mounted on a ship.

The supplementary thrust generating apparatus 200 according to another embodiment of the present invention is the same as an embodiment of the present invention described above except the object (e.g. ship) 10 having the curved surface is mounted on only a part of the outer circumferential surface 21, and as a result, hereinafter, this will be primarily described.

The supplementary thrust generating apparatus 200 according to another embodiment of the present invention may be mounted on a ship 10B among the objects 10 having the curved surface only a part of the outer circumferential surface 21 as illustrated in FIG. 5. In this case, the external pressure P may be a water pressure which the ship 10B receives while the ship 10B is propelled.

In particular, a part of an outer circumferential surface 21 of the ship 10B may form the curved surface. In this case, so as for the plurality of thrust conversion units 130 to smoothly operate with respect to the curved surface, as illustrated in FIG. 4, the outer support unit 120 may be divided into a plurality of outer support sections including a first outer support section 120A and a second outer support section 120B, and the plurality of thrust conversion units 130 may be distinguished into a plurality of thrust conversion sections including a first thrust conversion section 130A and a second thrust conversion section 130B. Since the respective components thereof are the same as those of an embodiment of the present invention, a detailed description thereof will be omitted, and denoted by the same reference numeral as those of an embodiment.

While a preferred embodiment of the present invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

### EXPLANATION OF REFERENCE NUMERALS AND SYMBOLS

10: Object (object having propulsion device)
10A: Airplane
10B: Ship
100: Supplementary thrust generating apparatus
110: Inner support unit
120: Outer support unit
121: Outer support frame
122: Outer main skin
123: Outer connection skin
120A: First outer support section
120B: Second outer support section
130: Thrust conversion unit
131: Thrust conversion member
132: Fixation unit
133: Hinge unit
130A: First thrust conversion section
130B: Second thrust conversion section
140: Intermediate connection support unit
F1: Thrust of object by propulsion device
F2: Supplementary thrust
P: External pressure
θ1: Acute angle
θ2: Obtuse angle

1. A supplementary thrust generating apparatus used for an object having a propulsion device, wherein the supplementary thrust generating apparatus is provided on an outer surface of the object, and converts an external pressure applied to the object while the object is propelled by the propulsion device, and generates a supplementary thrust in the same direction as a thrust direction of the propulsion device.

2. The supplementary thrust generating apparatus of claim 1, comprising:
an inner support unit provided on an outer surface of the object;
an outer support unit provided at an interval from the inner support unit; and
a plurality of thrust conversion units provided between the inner support unit and the outer support unit, and converting the external pressure applied to the outer support unit into the supplementary thrust, and transferring the supplementary thrust to the inner support unit.

3. The supplementary thrust generating apparatus of claim 2, wherein each thrust conversion unit includes a thrust conversion member having a long shape placed to be inclined to form an acute angle with respect to the outer support unit in the thrust direction and form an obtuse angle with respect to the inner support unit, and including one end portion provided at the inner support unit and the other end portion provided at the outer support unit.
